(19) United States
(12) Patent Application Publication
(10) Pub. No.: US 2019/0203029 A1
(43) Pub. Date: Jul. 4, 2019

(54) Sound absorbing material and preparation method thereof

(71) Applicant: AAC Technologies Pte. Ltd., Singapore city (SG)

(72) Inventors: Fateng Zhang, Shenzhen (CN); Ning Kang, Shenzhen (CN)

(21) Appl. No.: 16/236,341

(22) Filed: Dec. 28, 2018

(30) Foreign Application Priority Data
Jan. 4, 2018 (CN) 201810006520.1

(51) Int. Cl. C08L 33/04; C08K 7/24; C08L 9/06; B01J 2/02; B05B 7/14

(52) U.S. Cl. CPC C08L 33/04; C08K 7/24; C08L 9/06; B05B 7/149; B05B 7/1422; B05B 7/1486; B01J 2/02

(57) ABSTRACT

The present disclosure provides a sound absorbing material and a preparation method thereof. The sound absorbing material includes a porous powder core and an adhesive coating the porous powder core. A porous powder dispersion solution and an adhesive dispersion solution are simultaneously subjected to spray granulation via a nozzle having an inner ring nozzle and an outer ring nozzle, so that the porous particles having a structure including a porous powder core and an adhesive coating the porous powder core are formed. The porous particles prepared by the method of the present disclosure when serving as a sound absorbing material of a sounding device have high strength and is not easy to be broken. Moreover, a total amount of the adhesive used in the method of the present disclosure is less than that in the conventional method, so that cost is effectively saved.

### CROSS-REFERENCE TO RELATED APPLICATIONS

The present application claims priority to Chinese Patent Application No. 201810006520.1, filed on Jan. 4, 2018, the content of which is incorporated herein by reference in its entirety.

### TECHNICAL FIELD

The present disclosure relates to a sound absorbing material and a preparation method thereof and, in particular, to sound absorbing particles with uneven distribution of adhesive and a preparation method thereof.

### BACKGROUND

With the rapid development of portable electronic products such as mobile phones, functional requirements for products are getting higher and higher. Since the chamber thereof is a closed structure and has a relatively small volume, resonant frequency of a sounding device thereof is high, resulting in poor low frequency performance of the sounding device. Therefore, it is difficult to produce a rich bass effect. At present, porous powders are generally used in the industry to make porous particles, and these particles are placed into the sound chamber to reduce f₀ of the sounding device and improve bass effect.

However, when the porous material is applied to the speaker, there are collision and breakage of the porous particles in the chamber. A part of the broken porous particles can enter the speaker, causing a problem of noise. In order to solve this problem, the most direct method is to increase content of an adhesive, but it may have a problem that the content of the porous particles is low and the effect is deteriorated.

Based on these problems, it is necessary to provide a new sound absorbing material and a preparation method thereof, in order to effectively avoid failure caused by broken porous particles and improve sound absorbing effect.

### BRIEF DESCRIPTION OF DRAWINGS

In order to more clearly illustrate technical solutions of embodiments of the present disclosure, the accompanying drawings used in the embodiments are briefly described below. The drawings described below are merely a part of the embodiments of the present disclosure. Based on these drawings, those skilled in the art can obtain other drawings without any creative effort.

FIG. 1 is a schematic view showing a spray granulation nozzle used in the present disclosure.

FIG. 2 is a schematic view showing a structure of a sound absorbing material prepared by an embodiment of the present disclosure.

FIG. 3 is a graph showing an impedance curve of a speaker filled with the sound absorbing material prepared in an embodiment of the present disclosure.

FIG. 4 is a graph showing frequency response of a speaker filled with the sound absorbing material prepared in an embodiment of the present disclosure.

### DESCRIPTION OF EMBODIMENTS

In order to clearly illustrate the above objects, features and advantages of the present disclosure, the present disclosure are described below in details in conjunction with the specific embodiments of the present disclosure.

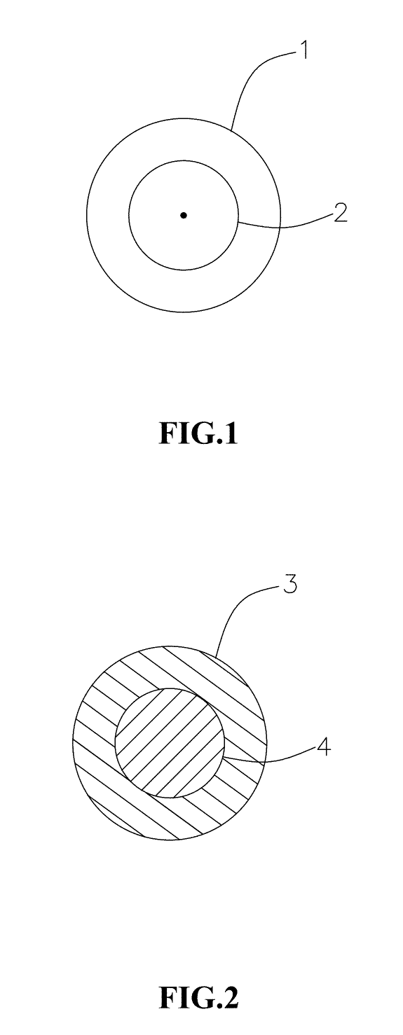

The present disclosure proposes a method for preparing porous sound absorbing particles in which the porous particles are formed by spray drying techniques. The nozzle used herein has a structure shown in FIG. 1, and includes an outer ring nozzle 1 and an inner ring nozzle 2. The inner ring nozzle 2 is configured to spray porous powder and dispersant, and the outer ring nozzle 1 is configured to spray adhesive and dispersant. Thus, porous particles structured in a manner that porous powders are coated by adhesive can be obtained. The porous sound absorbing particles obtained by the method proposed by the present disclosure have a structure as shown in FIG. 2. A central portion of the structure is porous powders 4, the periphery portion of the structure is an adhesive 3 that is coated. The porous particles prepared by the method of the present disclosure when serving as a sound absorbing material of the speaker have high strength and are not easy to break. Moreover, a total amount of the adhesive used in the method of the present disclosure is less than that in the conventional method, so that cost is effectively saved.

The porous powder suitable for the method of the present disclosure may include, but is not limited to, a porous silica gel material, a molecular sieve material, a porous graphite material, and a porous carbon black. Optionally, the molecular sieve material is selected.

The adhesives suitable for the method of the present disclosure may include, but are not limited to, a polystyrene emulsion, a polystyrene-acrylate emulsion, a polyacrylate emulsion, a polyvinyl acetate-acrylate emulsion, a polybutadiene-styrene emulsion, a polyethylene-vinyl acetate emulsion, a polyvinyl alcohol aqueous solution, a polyvinylpyrrolidone aqueous solvent, a polyacrylic acid aqueous solution, a polyacrylamide aqueous solution, a protein aqueous solution, a modified cellulose aqueous solution, and a soluble starch solution. Most optionally, the adhesive is selected from an acrylate emulsion and a butadiene-styrene emulsion.

In the preparation method, a ratio of the porous powder, the adhesive (based on a dry adhesive), and water is 100:(6-16):(200-1000). Optionally, the above ratio is 100:(8-12):(300-500).

A spray pressure used in the preparation method ranges from 0.02 to 0.1 MPa; optionally, the spray pressure is 0.08 MPa.

A drying temperature used in the preparation method ranges from 50 to 150° C.; optionally, the drying temperature ranges from 80 to 120° C.

### Example 1

A dispersion solution a of a porous powder used as a sound absorbing raw material was formulated in a mass ratio 1:1 of the porous powder to water.

A dispersion solution b of an adhesive is formulated in a mass ratio 1:1.5 of the adhesive having a 50 wt % solid content to water.

The solution a and the solution b in a ratio of 6:1, that is, the ratio of the adhesive being 5.88%, were spray granulated via a spray gun having an outer ring nozzle 1 and an inner ring nozzle 2. The solution b was sprayed by the outer ring nozzle 1, and the solution a was sprayed by the inner ring nozzle 2. The formed sound absorbing particles having a particle size of 350 μm-450 μm are selected by sieving in order to test strength, performance of filling a sounding device and situation of broken powders after a drop test.

### Example 2

A dispersion solution a of a porous powder as a sound absorbing raw material was formulated in a ratio 1:0.8 of the porous powder to water.

A dispersion solution b of an adhesive is formulated in a ratio 1:2 of the adhesive having a 50% solid content to water.

The solution a and the solution b in a ratio of 7.5:1, i.e., the ratio of the adhesive being 4%, were spray granulated via a spray gun having an outer ring nozzle 1 and an inner ring nozzle 2. The solution b was sprayed by the outer ring nozzle 1, and the solution a was sprayed by the inner ring nozzle 2. The formed sound absorbing particles having a particle size of 350 μm-450 μm are selected by sieving in order to test strength, performance of filling a sounding device and situation of broken powders after a drop test.

### Example 3

A dispersion solution a of a porous powder as a sound absorbing raw material was formulated in a ratio 1:1.2 of the porous powder to water.

A dispersion solution b of an adhesive is formulated in a ratio 1:2.9 of the adhesive having a 50% solid content to water.

The solution a and the solution b in a ratio of 4:1, i.e., the ratio of the adhesive being 7.05%, were sprayed for spray granulation via a spray gun having an outer ring nozzle 1 and an inner ring nozzle 2. The solution b was sprayed by the outer ring nozzle 1, and the solution a was sprayed by the inner ring nozzle 2. The formed sound absorbing particles having a particle size of 350 μm-450 μm are selected by sieving in order to test strength, performance of filling a sounding device and situation of broken powders after a drop test.

In the conventional spray granulation, the porous powder and the adhesive are formulated into a uniform liquid to be spray granulated. The porous powder and the adhesive in the formed porous particles have no clear boundary, but form a uniform body.

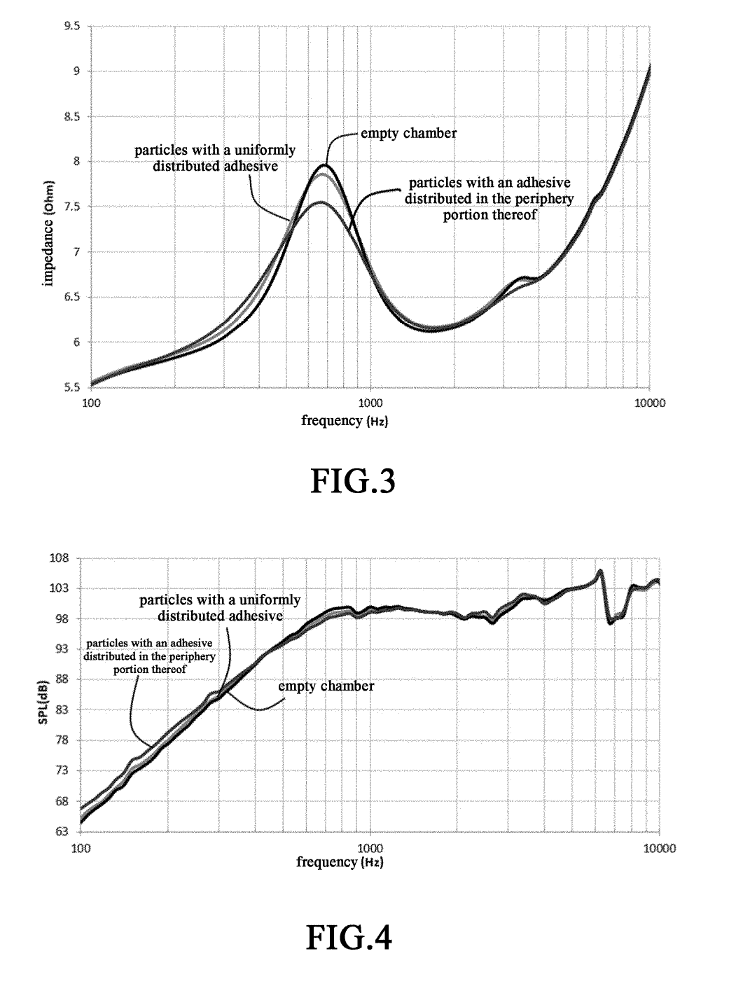

Referring to FIG. 3, impedance curves were tested for a sounding device with an empty chamber, a sounding device filled with conventional sound absorbing particles with a uniformly distributed adhesive, and a sounding device filled with sound absorbing particles with an adhesive distributed in the periphery portion thereof prepared by the present disclosure. It can be seen from the test results that the sounding device using the sound absorbing particles prepared by the present disclosure has a lowest f₀ and has a lowest impedance at f₀.

Referring to FIG. 4, frequency response curves were tested for a sounding device with an empty chamber, a sounding device filled with conventional sound absorbing particles with a uniformly distributed adhesive, and a sounding device filled with sound absorbing particles with an adhesive distributed in the periphery portion thereof prepared by the present disclosure. It can be seen that at a low frequency stage, the sounding device using the sound absorbing particles prepared by the present disclosure have a better gain.

The sounding device was filled with the sound absorbing particles prepared by the present disclosure, and then subjected to a drop test. After the drops have been performed 40,000 times, the sounding device is opened and the mesh thereof was checked, the result showed that no powders had been leaked out and no fine powders were peeled off on the surface of the mesh. It can be seen that the sound absorbing particles prepared by the present disclosure have excellent strength.

The above are merely embodiments of the present disclosure. Here, it should be noted that those skilled in the art can make modifications without departing from the inventive concept of the present disclosure, but these modifications shall fall into the protection scope of the present disclosure.

What is claimed is:

1. A sound absorbing material, comprising: a porous powder core and an adhesive coating the porous powder core.

2. The sound absorbing material as described in claim 1, wherein the porous powder core comprises at least one of porous silica gel, molecular sieve, porous graphite, and porous carbon black.

3. The sound absorbing material as described in claim 1, wherein the adhesive comprises at least one of a polystyrene emulsion, a polystyrene-acrylate emulsion, a polyacrylate emulsion, a polyvinyl acetate-acrylate emulsion, a polybutadiene-styrene emulsion, a polyethylene-vinyl acetate emulsion, a polyvinyl alcohol aqueous solution, a polyvinylpyrrolidone aqueous solvent, a polyacrylic acid aqueous solution, a polyacrylamide aqueous solution, a protein aqueous solution, a modified cellulose aqueous solution, and a soluble starch solution.

4. A method for preparing a sound absorbing material, comprising:
formulating a first dispersion aqueous solution of a porous powder;
formulating a second dispersion aqueous solution of an adhesive; and
spray granulating the first dispersion aqueous solution and the second dispersion aqueous solution in proportion,
wherein the spray granulating is performed with a spray granulation nozzle having a double-ring nozzle structure, an inner ring nozzle of the double-ring nozzle structure is used for spray granulating the first dispersion aqueous solution, and an outer ring nozzle of the double-ring nozzle structure is used for spray granulating the second dispersion aqueous solution.

5. The method as described in claim 4, wherein the porous powder comprises at least one of porous silica gel, molecular sieve, porous graphite, and porous carbon black.

6. The method as described in claim 4, wherein the adhesive comprises at least one of a polystyrene emulsion, a polystyrene-acrylate emulsion, a polyacrylate emulsion, a polyvinyl acetate-acrylate emulsion, a polybutadiene-styrene emulsion, a polyethylene-vinyl acetate emulsion, a polyvinyl alcohol aqueous solution, a polyvinylpyrrolidone aqueous solvent, a polyacrylic acid aqueous solution, a polyacrylamide aqueous solution, a protein aqueous solution, a modified cellulose aqueous solution, and a soluble starch solution.

7. The method as described in claim 4, wherein a mass ratio of the porous powder to water in the first dispersion aqueous solution ranges from 0.8:1 to 1.2:1.

8. The method as described in claim 4, wherein the adhesive has a solid content of 50 wt %, and a mass ratio of the adhesive having the solid content of 50 wt % to water in the second dispersion aqueous solution ranges from 1:1.5 to 1:3.

9. The method as described in claim 4, wherein a mass ratio of the first dispersion aqueous solution to the second aqueous solution ranges from 4:1 to 8:1.

10. The method as described in claim 4, wherein the spray granulating is conducted under a spray pressure of 0.02 MPa to 0.1 MPa and at a drying temperature of 50° C. to 150° C.
